(19) United States
(12) Patent Application Publication
(10) Pub. No.: US 2015/0229513 A1
(43) Pub. Date: Aug. 13, 2015

(54) SYSTEMS AND METHODS FOR EFFICIENT REMOTE SECURITY PANEL CONFIGURATION AND MANAGEMENT

(71) Applicant: UTC FIRE & SECURITY AMERICAS CORPORATION, INC., Bradenton, FL (US)

(72) Inventors: Phani Pavan Kumar Mangaiahgari, Hyderabad (IN); Ananthakrishnan N., Hyderabad (IN); Boby Kuriakose, Hyderabad (IN)

(73) Assignee: UTC FIRE & SECURITY AMERICAS CORPORATION, INC., Brandenton, FL (US)

(21) Appl. No.: 14/423,862

(22) PCT Filed: Aug. 22, 2013
(86) PCT No.: PCT/US2013/056131

§ 371 Date: Feb. 25, 2015

Related U.S. Application Data
(60) Provisional application No. 61/694,030, filed on Aug. 28, 2012.

(51) Int. Cl. H04L 12/24; H04L 29/08; G06F 9/445

(52) U.S. Cl. CPC H04L 41/082; G06F 8/65; H04L 67/10

(57) ABSTRACT

A system for remote management of security panels is disclosed. A security panel can listen for and receive an SMS message from a management server. The SMS message can include parameters for establishing a network connection with the management server. The security panel can parse the SMS message to identify the parameters and utilize the parameters to establish a connection with the management server. The security panel can receive commands or instructions from the management server via the established connection.

### FIELD

The systems and methods pertain to remote security panel configuration and management.

### DESCRIPTION OF THE PRIOR ART

Global computer networks, such as the Internet, can allow security system users to remotely access on-site security panels that control the security system. Various programs or applications can communicate with an on-site security panel and allow a user to operate the security panel remotely similar to how the use would operate the security panel on-site. For example, the user can remotely activate or deactivate alarms, motions sensors, and safety systems; control and view live feeds from surveillance cameras; lock or unlock doors and windows; etc. However, not all functions of the security panel can be operated remotely. For example, a non-activated security panel may not have the connection parameters required to receive remote commands, such as the Internet Protocol (hereinafter, “IP) address of an intermediary management server. Accordingly, the security panel may require an on-site installer to activate the security panel and enable remote operation before the security panel can be used or accessed remotely.

Further, once a security panel is configured to allow for remote operation, existing solutions can require the security panel to periodically ping a security panel management server to determine whether a remote command has been submitted. Accordingly, such solutions can result in excessive network traffic to frequently ping a server, or a remote command may be delayed if the server is pinged infrequently as the security panel can only discover that a command has been submitted after pinging the server.

Therefore, there is a need for a security panel management system that can remotely activate and configure security panels and minimize communication traffic and delays caused by intervals between pings.

### SUMMARY

According to embodiments, a security panel management system is disclosed. In certain embodiments, the system comprises a server configured to manage security panels. The server is further configured to send a Short Message Service (hereinafter, “SMS”) message comprising connection parameters to a security panel, and communicate with the security panel via a network connection established using the connection parameters.

In further embodiments, the system comprises a security panel configured to receive an SMS message comprising connection parameters, parse the SMS message to identify the connection parameters, and establish a network connection with a communication server using the connection parameters.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a diagram depicting an exemplary security panel management environment, consistent with certain disclosed environments.

FIG. 2 is a diagram depicting an exemplary security panel, consistent with certain disclosed environments.

FIG. 3 is a flow diagram depicting an exemplary sequence of security panel management communications, consistent with certain disclosed environments.

### DESCRIPTION OF THE EMBODIMENTS

With reference now to the various drawing figures in which identical elements are numbered identically throughout, a description of the embodiments will now be provided.

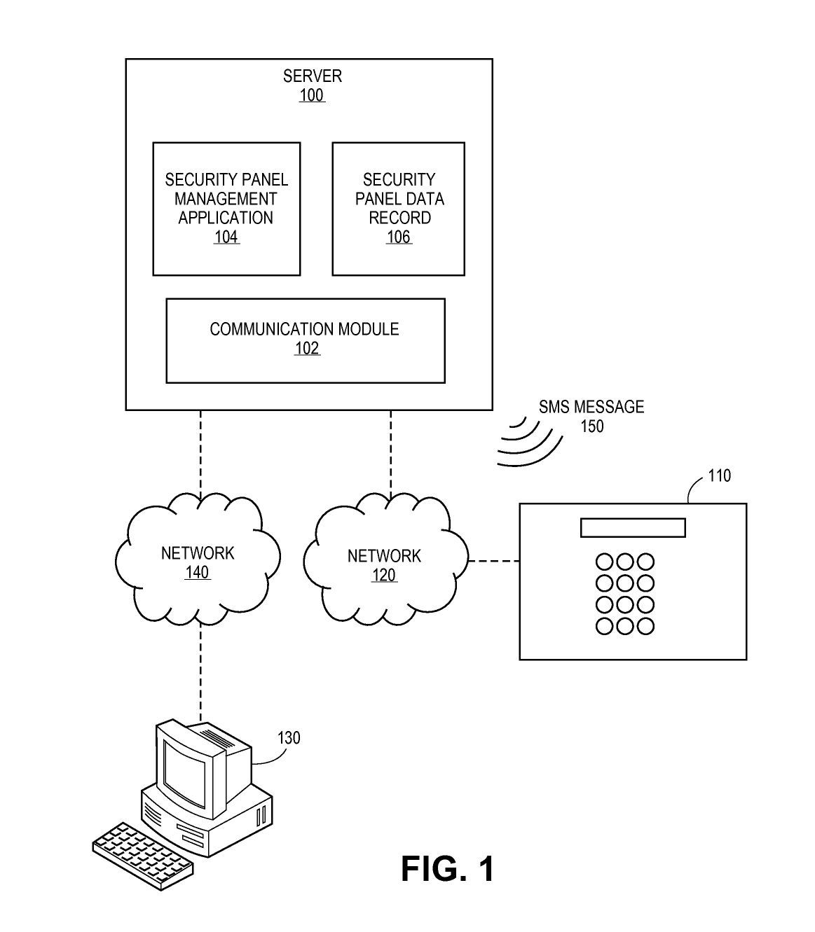

FIG. 1 is a diagram depicting an exemplary security panel management environment, consistent with certain disclosed environments. The environment comprises server 100 connected to security panel 110 via network 120. Network 120 can be, for example, a global or wide area network, such as the Internet. In some cases, network 120 can be a local area network. Server 100 can have communication module 102 implemented thereon. Server 100 can connect to network 120 via communication module 102.

In embodiments, security panel 110 can be configured to receive commands, activation instructions, and configuration instructions and operate a security system based on such commands or instructions. For example, security panel 110 can be configured to receive commands to perform operations including activating motion detectors, configuring alarm systems, turning on lights, and locking doors. It should be appreciated that while FIG. 1 depicts a single security panel 110, security panel 110 can represent a plurality of security panels that are individually managed by the system.

Server 100 can have security panel management application 104 implemented thereon. In particular, security panel management application 104 can be a local or online service platform that allows users to remotely manage one or more security panels. As used herein, a “user” or “users” refers to any administrator of a third party company, any individual, or any other entity that remotely operates security panel 110.

In some implementations, security panel management application 104 can allow a user local to server 100, such as a system administrator, to communicate instructions or commands to security panel 110. In further embodiments, a user can remotely communicate with server 100 from computing device 130 via network 140. Although network 120 and network 140 are depicted in FIG. 1 as representing two separate networks, in some embodiments, network 120 and network 140 can represent the same communication network. Additionally, computing device 130 can represent any type of computing device capable of communicating with server 100 via network 140, such as a desktop computer, laptop, cellular phone, or tablet computer.

Server 100 can additionally have security panel data record 106 implemented thereon. In particular, security panel data record 106 can be utilized to store data related to security panel 110. For example, security panel data record 106 can be utilized to store one or more of the Mobile Station International Subscriber Directory Number (MSISDN), serial number, Media Access Control (MAC) address, subscriber identity module (SIM) details, SIM Integrated Circuit Card Identifier (ICCID), International Mobile Equipment Identity (IMEI) number, modem details, IP address, and preferred port number of security panel 110. Additionally, security panel data record 106 can be utilized to store information related to individual security equipment of the security system, such as serial numbers of motion sensors, video cameras, etc.

In embodiments, server 100 can receive the above security panel data record 106 information from the manufacturer of security panel 110. For example, such information can be received from the manufacturer via a network connection. Or, as an additional example, a user local to server 100 can manually enter the security panel data record 106 information into server 100.

Computing device 130 can implement and/or support a security panel remote access application. For example, the security panel remote access application can be a mobile phone application, a web application, or any other type of program that allows a user to select commands or instructions to send to security panel 110. The security panel remote access application can send any commands selected by the user to server 100 via network 140.

In embodiments, after server 100 receives commands or instructions from a user, either via network 140 or via direct input from a user local to server 100, server 100, using communication module 102, can send SMS message 150 to security panel 110 before communicating the commands or instructions to security panel 110 via network 120. Server 100 can send SMS message 150 to security panel 110 using a unique MSISDN associated with security panel 110. Additionally, server 100 can send SMS message 150 using any network capable of utilizing SMS technology, for example, a cellular network or a broadband network. Further, SMS message 150 can include one or more characters of text and can utilize any standard set or communication protocol compatible with SMS technology, such as Global System for Mobile Communications (GSM®), General Packet Radio Service (GPRS), 3rd generation mobile telecommunications standards (3G), 4th generation mobile telecommunications standards (4G), Simple Mail Transfer Protocol (SMTP), Transmission Control Protocol (TCP), and IP.

In embodiments, server 100 can dial and give a predefined number of ringtones to the modem of security panel 110 via, for example, GSM® or plain old telephone service (POTS). The predefined number of ringtones can serve as an indication to security panel 110 that server 100 is attempting to or will attempt to establish a connection with security panel 110. Accordingly, security panel 110 is not required to frequently ping or be permanently connected to server 100 to receive commands.

In operation, for example, SMS message 150 can include a “Wake Up” command instructing security panel 110 to establish a network connection, via network 120, with server 100. In some embodiments, a “Wake Up” command may not be necessary, and the receipt of SMS message 150 can communicate to security panel 110 the instruction to establish a network connection with server 100. Additionally, SMS message 150 can include an indication of the type of communication forthcoming. For example, SMS message 150 can indicate that server 100 will transmit a command as part of the communication. Further, SMS message 150 can include one or more connection parameters. Connection parameters can include, but are not limited to, the IP address of server 100, the Domain Name System (DNS) name of server 100, and the port number of server 100 for the communication session. SMS message 150 can also include one or more parsing characters, such as a space, a comma, or infrequently used characters, to allow security panel 110 to efficiently parse SMS message 150. Examples of SMS message 150 can include:

```
  <WAKEUP>  <ACTIVATION>  <SERVER:192.168.150.152>
<PORT:80>;
  DOWNLOAD, SERVER:192.222.154.125, PORT:443; and
  USERCOMMAND 192.168.150.152 80.
```

Additionally, SMS message 150 can include passcode or other security information that can allow security panel 110 to identify that SMS message 150 originated from an authorized source. In further embodiments, security panel 110 can maintain a list of authorized server IP addresses and match any received IP address with a listed authorized server IP address before executing any instructions. In still further embodiments, SMS message 150 can be encoded before transmission by server 100 and can be decoded after transmission by security panel 110 to prevent unauthorized access.

After security panel 110 receives SMS message 150 from server 100, security panel can parse the SMS message to identify, for example, the type of communication forthcoming, the IP address of server 100, and the port number of server 100 for the communication session. Subsequently, security panel 110 can establish a network connection, via network 120, with server 100 using the identified IP address of server 100 and the identified port number of server 100. After the connection is established, server 100 can transmit data to security panel 110, including, for example, any commands selected by a user from computing device 130, firmware updates for the security panel, configuration instructions, and activation instructions. Security panel 110 can thereafter perform the user selected commands, install the firmware updates, and/or execute the configuration or activation instructions.

In embodiments, communications between security panel 110 and server 100 can utilize cryptographic protocols to prevent unauthorized access to security panel 110. Such cryptographic protocols can include Secure Sockets Layer (SSL), Point-to-Point Protocol (PPP), etc. For example, security panel 110 can utilize SSL to communicate with server 100 and can utilize an SSL certificate to validate or authorize the identity of server 100.

Additionally, in some embodiments, not every SMS message received by security panel 110 will initiate a connection to server 100. For example, server 100 can send SMS message 150 to security panel 110, and SMS message 150 can contain complete configuration instructions that do not require further instructions via a connection with server 100. Therefore, SMS message 150 may not contain connection parameters, and security panel 110 can perform the configuration instructions without connecting to server 100.

In some cases, security panel 110 can submit results from the performed command or executed instructions to server 100. For example, security panel 110 can receive a command to activate an alarm system, successfully perform the command, and then submit a result to server 100 that includes an indication that the alarm system was activated successfully. As a further example, security panel 110 can receive a command to stream a live feed from a surveillance camera and then submit a result to server 100 that includes a streaming live feed from the surveillance camera. In certain embodiments, server 100 can relay the results received from security panel 110 to computing device 130.

In some embodiments, after data has been transmitted to security panel 110 using the network connection, server 100 and/or security panel 110 can terminate the network connection. Once the network connection is terminated, security panel 110 can begin or return to an SMS listening state. During the SMS listening state, security panel 110 can wait for the next SMS message from a server and is not required to ping the server to identify if a command or instruction has been submitted.

It should be appreciated that the environment depicted in FIG. 1 is merely exemplary and can comprise various combinations and types of components. For example, although server 100 is pictured as a single device, server 100 can include a plurality of devices that are connected locally and/or are connected via a network connection. Further, although computing device 130 is depicted as only communicating with server 100, in certain embodiments, computing device 130 can be configured to directly communicate with security panel 110. For example, computing device 130 can be configured to send an SMS message directly to security panel 110 based on instructions selected by a user. Additionally, in some embodiments, security panel 110 can establish a connection directly with computing device 130.

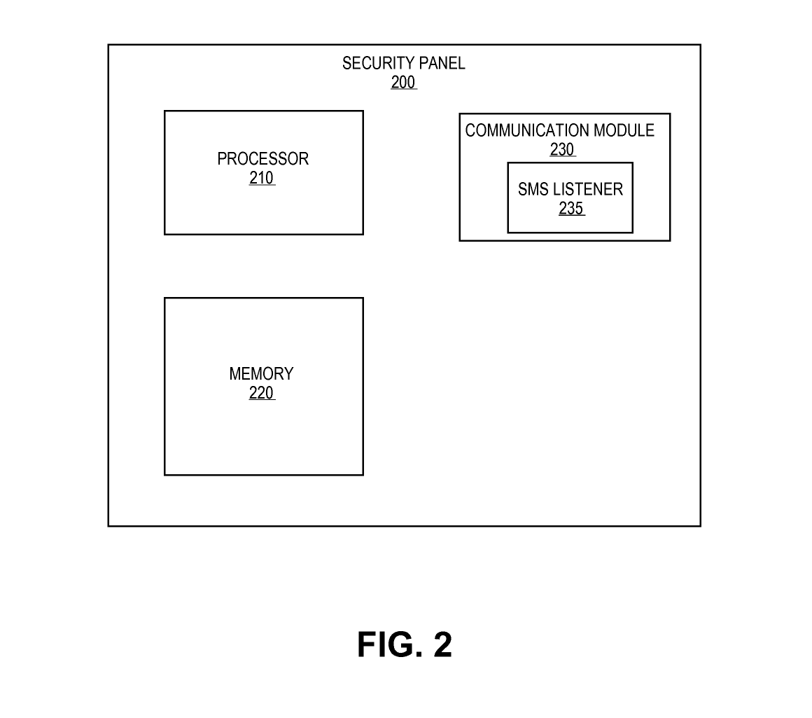

Referring to FIG. 2, depicted is an exemplary security panel 200 and components thereof. It should be appreciated that FIG. 2 represents a generalized schematic illustration and that other components and/or entities can be added or existing components and/or entities can be removed or modified.

As shown in FIG. 2, security panel 200 can comprise processor 210 communicating with memory 220, such as electronic random access memory, or other forms of transitory or non-transitory computer readable storage mediums. Processor 210 can further communicate with communication module 230, such as a wired or wireless data connection, which in turn communicates with a wide area network, such as various public or private networks. More particularly, the wide area network can connect security panel 200 to one or more security panel management servers, such as server 100 as discussed with respect to FIG. 1, and/or other components. Communication module 230 can include SMS listener 235, which can listen for and receive SMS messages.

Processor 210 can execute control logic and perform data processing to perform the functions and techniques as discussed herein. For example, processor 210 can execute commands received from a security panel management server, such as sending signals to activate motion sensors, activate alarms, lock doors, etc.

As used herein, “security panel” can refer to any type of apparatus or system capable of managing or controlling one or more elements of a security system. Additionally, while FIG. 2 illustrates security panel 200 as a standalone system using a combination of hardware and software, the components of security panel 200 can also be implemented as a software application or program capable of being executed by a conventional computer platform. Likewise, the components of security panel 200 can also be implemented as a software module or program module capable of being incorporated in other software applications and programs. In either case, the components of security panel 200 can be implemented in any type of conventional proprietary or open-source computer language.

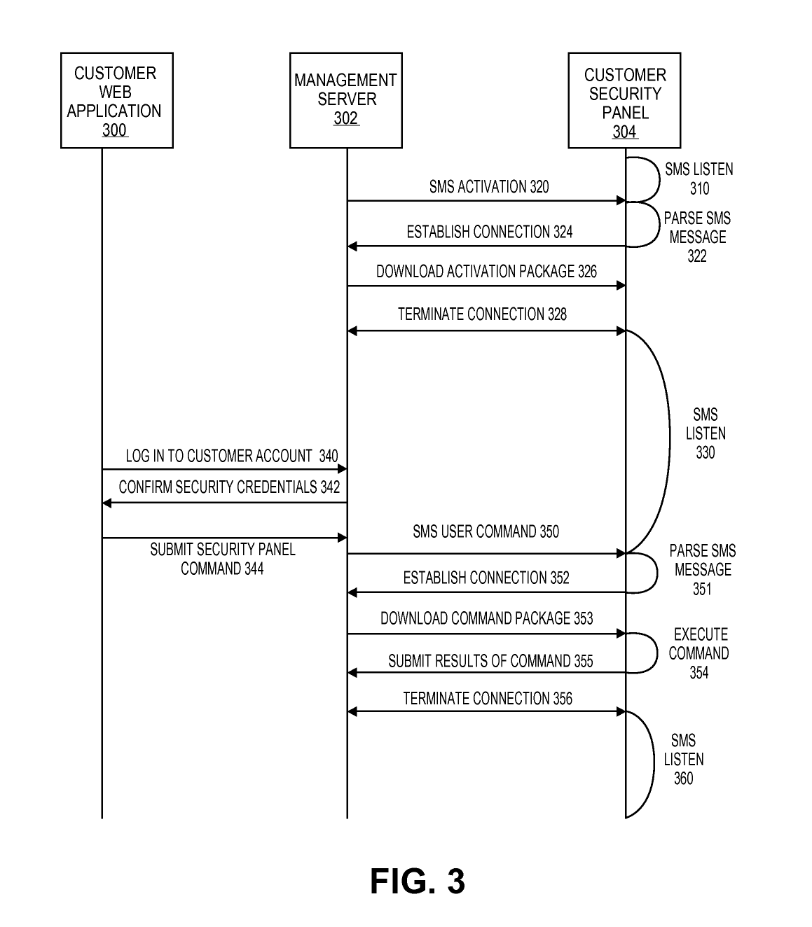

Referring to FIG. 3, depicted is a flowchart detailing embodiments as described herein. More particularly, the flowchart details communications and interactions among customer web application 300, management server 302, and customer security panel 304. It should be appreciated that the flowchart of FIG. 3 is merely exemplary and can comprise more or fewer functionalities.

The flowchart begins with customer security panel 304 listening for an SMS message (310). Management server 302 can send an SMS activation message (320) to customer security panel 304. The SMS activation message can include one or more communication parameters, as described above. Customer security panel 304 can parse the SMS message (322) and identify the forthcoming communication type and communication parameters, and then establish a connection (324) with management server 302 using the communication parameters. Management server 302 can transmit and customer security panel 304 can download an activation package (326) using the established connection. After the activation package has been transferred, management server 302 and/or customer security panel 304 can terminate the established connection (328). The activation package can include activation instructions, configuration instructions, and/or firmware updates for customer security panel 304, and customer security panel 304 can execute the instructions and/or the updates before, after, or while terminating the connection with management server 302. After the connection is terminated, customer security panel 304 can return to listening for a new SMS message (330).

At a subsequent time, the customer can attempt to log in to a customer account (340) associated with management server 302 and customer security panel 304. Management server 302 can verify the security credentials of the user (342) and grant the user access to the account. Once the user has access to the account, the user can submit a security panel command (344) to management server 302. For example, the customer can submit a command instructing the customer security panel to activate the alarm system.

Management server 302 can send an SMS user command message (350) to customer security panel 304. The SMS command message can include one or more communication parameters, as described above. Customer security panel 304 can parse the SMS message (351) and establish a connection (352) with management server 302, as described above. Management server 302 can transmit and customer security panel 304 can download a user command package (353) using the established connection. After the command package has been transferred, customer security panel 304 can execute the command (354) and store the results of the command. For example, customer security panel 304 can instruct the alarm system to activate and store a result that the alarm system activated correctly. Customer security panel 304 can then submit the results of the command (355) to management server 302. Then management server 302 and/or customer security panel 304 can terminate the established connection (356). After the connection is terminated, customer security panel 304 can return to listening for a new SMS message (360).

It has been shown how the present embodiments have been attained. Modification and equivalents of the disclosed concepts are intended to be included within the scope of the claims, which are appended hereto.

What is claimed is:

1. A security apparatus comprising:
a processing system comprising one or more processors; and
a memory system comprising one or more computer-readable media, wherein the computer-readable media contain instructions that, when executed by the processing system, cause the processing system to perform operations comprising:
receiving an SMS message comprising one or more characters,
wherein the one or more characters comprise one or more parameters;
parsing the one or more characters to identify the one or more parameters; and
establishing a network connection with a communication server using the one or more parameters.

2. The security apparatus of claim 1, the operations further comprise receiving one or more commands from the communication server via the network connection.

3. The security apparatus of claim 1, the operations further comprise downloading a firmware update from the communication server via the network connection.

4. The security apparatus of claim 1, the operations further comprise receiving configuration instructions from the communication server via the network connection.

5. The security apparatus of claim 2, wherein the one or more commands are sent by the communication server in response to a request, via a web application, from a user.

6. The security apparatus of claim 2, the operations further comprise executing the one or more commands.

7. The security apparatus of claim 6, the operations further comprise:
determining one or more results based on the executing the one or more commands; and
sending the one or more results to the communication server via the network connection.

8. The security apparatus of claim 1, the operations further comprise receiving activation instructions from the communication server via the network connection.

9. A system for managing security systems comprising:
a server configured to communicate with security panels;
a processing system comprising one or more processors; and
a memory system comprising one or more computer-readable media, wherein the computer-readable media contain instructions that, when executed by the processing system, cause the processing system to perform operations comprising:
sending an SMS message comprising one or more characters to a security panel, wherein the one or more characters comprise one or more parameters; and
communicating with the security panel via a network connection established using the one or more parameters.

10. The system of claim 9, the operations further comprise sending one or more commands to the security panel via the network connection.

11. The system of claim 9, the operations further comprise transferring a firmware update to the security panel via the network connection.

12. The system of claim 9, the operations further comprise sending configuration instructions to the security panel via the network connection.

13. The system of claim 10, the operations further comprise:
receiving, from a web application, one or more instructions from a user; and
wherein the one or more commands are based on the one or more instructions from the user.

14. The system of claim 13, the operations further comprise receiving one or more results from the security panel via the network connection, wherein the one or more results are determined based on an execution of the one or more commands by the security panel.

15. The system of claim 9, the operations further comprise transferring activation instructions to the security panel via the network connection.
